(19) United States
(12) Patent Application Publication
(10) Pub. No.: US 2008/0032840 A1
(43) Pub. Date: Feb. 7, 2008

(54) Double-meshing type tooth chain

(75) Inventors: Volker Hirschmann, Furstenfeldbruck (DE); Michael Frank, Otterfing (DE); Andreas Bongard, Pahl (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: iwis motorsysteme GmbH & Co., KG, Munchen (DE)

(21) Appl. No.: 11/823,540

(22) Filed: Jun. 28, 2007

(30) Foreign Application Priority Data
Jun. 30, 2006 (DE) 202006010175.6

(51) Int. Cl. F16G 13/04

(52) U.S. Cl. 474/212

(57) ABSTRACT

A double-meshing type tooth chain, where each of the chain hinges is formed by a sleeve and by a pin extending through said sleeve, and the link plates of the inner chain links are arranged on the sleeves and the link plates of the outer chain links are arranged on the pins, and wherein the outer-chain-link link plate arranged on the pin and the inner-chain-link link plate, which is arranged on the sleeve and located adjacent to said link plate of the outer chain link, are oriented such that their teeth project in the same direction.

### CROSS-REFERENCE TO RELATED APPLICATION

The present application claims the benefit of priority of German Patent Application No. 202006010175.6 filed on Jun. 30, 2006. The entire text of the priority application is incorporated herein by reference in its entirety.

### FIELD OF THE DISCLOSURE

The present disclosure relates to a double-meshing type tooth chain.

### BACKGROUND OF THE DISCLOSURE

This type of tooth chain can be used for driving sprockets which are arranged on both sides of the circulating tooth chain, i.e. in the area enclosed by the tooth chain and outside of the tooth chain, and which rotate in different directions. Such tooth chains are used e.g. as timing chains in an internal combustion engine, when the motion of the crankshaft is to be transmitted not only to the camshaft but also to additional auxiliary units, such as an oil pump.

Double-meshing type tooth chains are already known from the prior art. In U.S. Pat. No. 6,440,022 B1, for example, a tooth chain is described, which comprises a plurality of link plates with identical profiles. The link plates are interconnected by chain pins, the teeth of the outer link plates being directed outwards and the teeth of the remaining, inner link plates being directed inwards. The tooth chain is in meshing engagement with a sprocket comprising a first outer circumferential portion and second outer circumferential portions formed on a one-piece cylindrical sprocket body. The first outer circumferential portion forms a support face for the link plates which are arranged such that their back faces the sprocket. The second outer circumferential portions are provided with teeth for meshing engagement with the teeth of the link plates facing the sprocket.

Similar double-meshing type tooth chains, in the case of which the teeth of the lateral, outer link plates are directed outwards and the teeth of the remaining, inner link plates are directed inwards, are known from US 2002/0025870 A1 and US 2002/0013191 A1.

These tooth chains are, however, disadvantageous with regard to their wear behavior.

### SUMMARY OF THE DISCLOSURE

It is therefore the object of the present disclosure to provide a double-meshing type tooth chain which, when sprockets engage the tooth chain both from inside and from outside, will accomplish a uniform load, prevent deformation and achieve a longer service life. In addition, the noise pollution and the vibration load are to be reduced.

Sprockets provided on the outer side of the tooth chain as well as sprockets provided on the inner side of the tooth chain will consequently engage link plates of the outer chain links and link plates of the inner chain links. This will result in a more uniform load on the chain and in an increase of the service life of the chain. The use of link plates allows an improved NVH behaviour. The chain hinges are each formed by a sleeve and by a pin extending through said sleeve, the link plates of the inner chain links being arranged on the sleeves and the link plates of the outer chain links being arranged on the pins. Due to the fact that the chain hinge pin extends through the sleeve, a reduction of wear is achieved. In addition, the reduced weight of the tooth chain including sleeves also contributes to an improved NVH behaviour. The outer-chain-link link plate arranged on the pin and the inner-chain-link link plate, which is arranged on the sleeve and located adjacent to said link plate of the outer chain link, are oriented such that their teeth project in the same direction. Hence, the shearing forces acting on the chain hinge will be reduced.

Another embodiment can be implemented such that the link plates of the outer chain links and of the inner chain links are arranged in pairs on the pins and sleeves, respectively, each pair of link plates being formed symmetrically with respect to the longitudinal axis of the tooth chain. A uniform load on and a uniform wear of the tooth chain can thus be achieved over the whole chain width.

Furthermore, the tooth chain can be implemented such that the outer chain links have on each side of the inner chain links at least two link plates whose teeth project in different directions. It follows that a sprocket located inside the tooth chain and a sprocket located outside the tooth chain will both engage the outer chain links.

Analogously, the inner chain links can be provided with at least two pairs of link plates and the teeth of the link plate pairs of the inner chain links can project in different directions. This will guarantee that a sprocket located inside the tooth chain and a sprocket located outside the tooth chain will both engage the inner chain links.

According to a preferred embodiment, the tooth chain can be implemented such that the outer chain links comprise four parallel link plates interconnected by two parallel pins, and that the inner chain links comprise four parallel link plates interconnected by two parallel sleeves, the teeth of the two outer link plates of each outer chain link projecting outwards, the teeth of the two outer-chain-link link plates, which face the inner chain link, and the teeth of the two adjacent link plates of each inner chain link projecting inwards, and the teeth of the two inner link plates of each inner chain link projecting outwards. The use of a sleeve hinge, in which the hinge pin extends in a sleeve, will reduce the wear of the chain hinge. The arrangement of the link plates of the outer chain links and of the inner chain links has the effect that a sprocket located outside of the circulating tooth chain comes into meshing engagement with the outer link plates of the outer chain links and the inner link plates of the inner chain links. The chain hinges have loads applied thereto not only at their ends but also in the middle. This leads to less deformation of the chain hinges and to less wear. Sprockets located inside the circulating tooth chain come into meshing engagement with the juxtaposed link plates of the outer chain links and of the inner chain links. This will reduce shear loads on the chain hinges and consequently also the amount of wear. Tests have shown that the combination of sleeve hinges with the above-described orientation of the link plates of the outer chain links and of the inner chain links contributes to an unexpectedly high increase in the service life of the double-meshing type tooth chain.

According to another variant, the respective outer link plates of the outer chain links and of the inner chain links are press-fitted onto the pins and sleeves, respectively, and the inner link plates of the outer chain links and of the inner chain links are attached to the pins and sleeves, respectively, in a loose fit. On the basis of these measures, the service life of the chain hinges and, consequently, also the service life of the chain can be increased still further.

The above-described tooth chain can be used with sprockets having attached thereto at least two spaced-apart gear rims. Hence, gear rims are arranged only on the outer circumferential portion of the sprocket at which the sprocket comes into meshing engagement with the tooth chain. The gear rims can be formed integrally with the gear rim body or they can be attached separately to said gear rim body.

A groove can be formed between the spaced-apart gear rims of the sprocket, said groove being engaged by the backs of the link plates whose teeth are directed away from the sprocket, whereby the tooth chain will be guided on the sprocket It is, however, also possible to provide a tooth chain with guide links which will guide the tooth chain on the sprocket.

The present disclosure additionally relates to a chain drive comprising a double-meshing type tooth chain provided with inner chain links and outer chain links, which are interconnected via chain hinges, and sprockets which are arranged on both sides of the tooth chain and which are in meshing engagement with said tooth chain, wherein both the inner chain links and the outer chain links of the tooth chain are provided with link plates whose teeth are directed inwards and with link plates whose teeth are directed outwards, each of the chain hinges is formed by a sleeve and by a pin extending through said sleeve, and wherein the link plates of the inner chain links are arranged on the sleeves and the link plates of the outer chain links are arranged on the pins, and wherein the outer-chain-link link plate arranged on the pin and the inner-chain-link link plate, which is arranged on the sleeve and located adjacent to said link plate of the outer chain link, are oriented such that their teeth project in the same direction, and wherein the sprockets have arranged thereon at least two spaced-apart gear rims which are in meshing engagement with the teeth of the tooth chain facing the sprocket. In this way, it is possible to obtain a timing drive by means of which the motion of the crankshaft can be transmitted not only to the camshaft but also to additional auxiliary units, such as an oil pump.

### BRIEF DESCRIPTION OF THE DRAWINGS

In the following, embodiments of the present disclosure will be explained in detail on the basis of a drawing, in which:

FIG. 1 shows a top view of a double-meshing type tooth chain,

FIG. 2 shows a section through a sprocket in meshing engagement with a double-meshing type tooth chain,

FIG. 3 shows a section through the tooth chain according to FIG. 2, along line B-B, and

FIG. 4 shows a chain drive comprising a double-meshing type tooth chain as well as sprockets which are arranged inside and outside of the tooth chain.

### DETAILED DESCRIPTION OF THE DRAWINGS

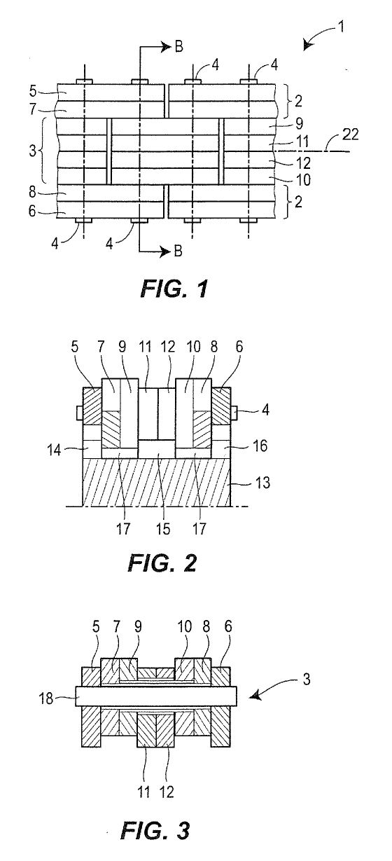

FIG. 1 shows a top view of a double-meshing type tooth chain 1. The tooth chain 1 comprises outer chain links 2 and inner chain links 3. The outer chain links 2 and the inner chain links 3 are arranged in blocks such that they are displaced relative to one another in the longitudinal direction of the tooth chain 1 and they are interconnected via chain hinges 4. Both the outer chain links 2 and the inner chain links 3 each comprise four link plates 5, 6, 7, 8; 9, 10, 11, 12. The two outer link plates 5, 6 of the outer chain links 2 are arranged such that their teeth are directed inwards. The teeth of the two outer-chain-link link plates 7, 8, which are arranged adjacent to the inner chain links 3, are directed outwards, so are the teeth of the inner-chain-link link plates 9, 10, which are arranged adjacent to said link plates 7, 8. The two inner link plates 11, 12 of the inner chain links 3 are, in turn, arranged such that their teeth are directed inwards. It follows that the outer chain links 2 as well as the inner chain links 3 are provided with link plates 5, 6; 11, 12 whose teeth are directed inwards as well as with link plates 7, 8; 9, 10 whose teeth are directed outwards.

The link plates 5, 6, 7, 8 of the outer chain links 2 as well as the link plates 9, 10, 11, 12 of the inner chain links 3 form link plate pairs 5, 6; 7, 8; 9, 10; 11, 12 which are symmetrical with respect to the longitudinal axis 22 of the tooth chain 1, the respective teeth of said link plate pairs being oriented in the same direction.

FIG. 2 shows the double-meshing type tooth chain 1 in meshing engagement with a sprocket 13. The circumference of the sprocket 13 has arranged thereon three spaced-apart gear rims 14, 15, 16. The sprocket 13 with the gear rims 14, 15, 16 can be implemented as a one-piece component. It is, however, also possible to attach the gear rims separately to a carrier.

As has already been described, the outer chain links 2 as well as the inner chain links 3 each comprise four link plates 5, 6, 7, 8; 9, 10, 11, 12 in the embodiment shown. The inwardly directed teeth of the outer link plates 5, 6 of the outer chain links 2 are in meshing engagement with the teeth of the gear rims 14, 16 of the sprocket 13. The juxtaposed link plates 7, 8; 9, 10 of the outer chain links 2 and of the inner chain links 3, whose teeth are directed outwards, are therefore arranged such that their back faces the sprocket. The link plates 11, 12 of the inner link plate pair of the inner chain links 3 are, in turn, arranged such that their teeth are directed towards the sprocket 13 and come into meshing engagement with the teeth of the gear rim 15 of the sprocket 13. Grooves 17 are formed between the gear rims 14, 15, 16, said grooves being engaged by the backs of the link plates 7, 8; 9, 10, whereby the tooth chain 1 is guided on the sprocket 13. It is, however, also possible to provide guide links in the tooth chain 1, which will fulfil this function.

The sprockets which are arranged outside of the circulating tooth chain 1 and which cooperate with the outer side of the said tooth chain are provided with only two spaced-apart gear rims cooperating with the teeth of the inner link plates 7, 8 of the outer chain links 2 and with the teeth of the outer link plates 9, 10 of the inner chain links 3. Also in this case, the sprocket can be formed integrally with the gear rims, or the gear rims can be attached separately to a carrier. The backs of the outer link plates 5, 6 of the outer chain links 2 and of the inner link plates 11, 12 of the inner chain links 3 run in grooves, which are arranged between the gear rims, and guide the tooth chain 1 on the sprocket. As has already been described, it is also possible to use guide links for this purpose.

The teeth of the juxtaposed link plates 7, 8; 9, 10 of the outer chain links 2 and of the inner chain links 3 come into meshing engagement with the same gear rims. Hence, the shearing forces acting on the pin 10 of the chain hinge 4 will be reduced.

FIG. 3 shows a section through the tooth chain 1 along the line B-B in FIG. 1 through a chain hinge 4. A chain hinge 4 consists of a pin 18 which is guided in a sleeve 19. The link plates 5, 6, 7, 8 of the outer chain links are arranged on the pin 18, the link plates 9, 10, 11, 12 of the inner chain links 3 are arranged on the sleeves 19. As can be seen in FIG. 3, only the outer link plates 5, 6; 9, 10 of the outer chain links 2 and of the inner chain links 3 are press-fitted onto the pins 18 and the sleeves 19, respectively. The inner link plates 7, 8; 11, 12 of the outer chain links 2 and of the inner chain links 3 are attached to the pins 18 and the sleeves 19, respectively, in a loose fit. A deformation of the pins 18 and of the sleeves 19 will be reduced in this way, whereby improved running of the pins 18 in the sleeves 19 will be achieved and whereby the amount of wear will be reduced.

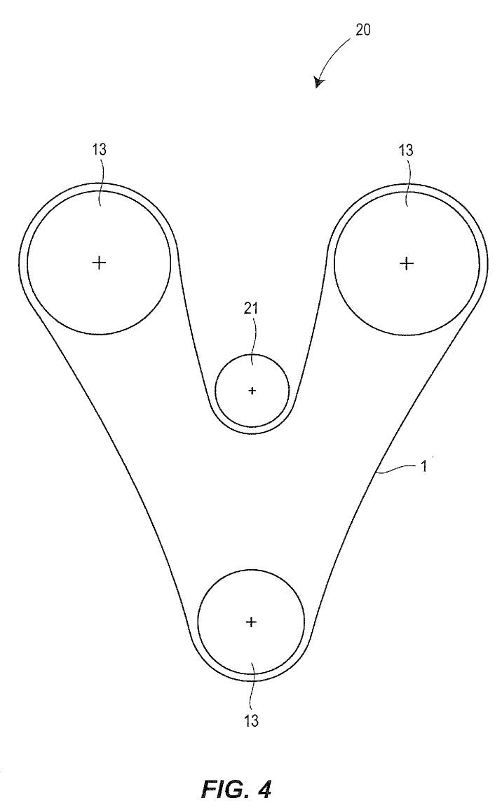

FIG. 4 shows a chain drive 20 comprising a double-meshing type tooth chain 1 and sprockets 13, 21. The tooth chain 1 comprises inner chain links 3 and outer chain links 2. Both the outer chain links 2 and the inner chain links 3 are provided with link plates 5, 6; 7, 8 whose teeth are directed inwards and with link plates 7, 8; 9, 10 whose teeth are directed outwards. Hence, the tooth chain 1 will be able to cooperate with sprockets 13 located inside of the tooth chain 1 as well as with sprockets 21 located outside of the tooth chain 1. This will be particularly advantageous in cases where the tooth chain is intended to be used for transmitting the motion of the crankshaft to the camshaft as well as for transmitting the motion of the crankshaft to an auxiliary unit, such as an oil pump.

1. A double-meshing type tooth chain (1) comprising outer chain links (2) and inner chain links (3) which are arranged in alternate succession and comprise link plates (5, 6, 7, 8; 9, 10, 11, 12) and which are interconnected via chain hinges (4), [both ]the outer chain links (2) and the inner chain links (3) are provided with link plates (5, 6; 11, 12) whose teeth are directed inwards and with link plates (7, 8; 9, 10) whose teeth are directed outwards, each of the chain hinges (4) is formed by a sleeve (19) and by a pin (18) extending through sleeve (19), the link plates (9, 10, 11, 12) of the inner chain links (3) are arranged on the sleeves (19) and the link plates (5, 6, 7, 8) of the outer chain links (2) are arranged on the pins (18), the outer-chain-link link plate (7, 8) is arranged on the pin (18), and the inner-chain-link link plate (9, 10), which is arranged on the sleeve (19) and located adjacent to the outer-chain-link plate (7, 8), are oriented such that their teeth project in the same direction.

2. A tooth chain (1) according to claim 1, wherein the link plates (5, 6, 7, 8; 9, 10, 11,12) of the outer chain links (2) and of the inner chain links (3) are arranged in pairs on the pins (18) and the sleeves (19), respectively, each pair of link plates (5, 6; 7, 8; 9, 10; 11,12) being provided symmetrically on both sides of the longitudinal axis (22) of the tooth chain (1).

3. A tooth chain (1) according to claim 1, wherein the outer chain links (2) have on each side of the inner chain links (3) at least two link plates (5, 6, 7, 8) whose teeth project in different directions.

4. A tooth chain (1) according to claim 1, wherein the inner chain links (3) are provided with at least two pairs of link plates (9, 10, 11, 12) and that the teeth of the link plate pairs (9, 10; 11, 12) of the inner chain links (3) project in different directions.

5. A tooth chain (1) according to claim 1, wherein the outer chain links (2) comprise four parallel link plates (5, 6, 7, 8) interconnected by two parallel pins (18), and that the inner chain links (3) comprise four parallel link plates (9, 10, 11, 12) interconnected by two parallel sleeves (19), the teeth of the two outer link plates (5, 6) of each outer chain link (2) projecting inwards, the teeth of the two outer-chain-link link plates (7, 8), which face the inner chain link (3), and the teeth of the two adjacent link plates (9, 10) of each inner chain link (3) projecting outwards, and the teeth of the two inner link plates (11, 12) of each inner chain link (3) projecting inwards.

6. A tooth chain (1) according to claim 1, wherein the respective outer link plates (5, 6; 9, 10) of the outer chain links (2) and of the inner chain links (3) are press-fitted onto the pins (18) and sleeves (19), respectively, and that the inner link plates (7, 8; 11, 12) of the outer chain links (2) and of the inner chain links (3) are attached to the pins (18) and sleeves (19), respectively, in a loose fit.

7. A chain drive (20) having a double-meshing type tooth chain (1), comprising inner chain links (3) and outer chain links (2), which are interconnected via chain hinges (4), sprockets (13, 21) which are arranged on both sides of the tooth chain and which are in meshing engagement with the tooth chain (1), both the inner chain links (3) and the outer chain links (2) of the tooth chain (1) are provided with link plates (11, 12; 5, 6) whose teeth are directed inwards and with link plates (9, 10; 7, 8) whose teeth are directed outwards, each of the chain hinges (4) is formed by a sleeve (19) and by a pin (18) extending through sleeve (19), and wherein the link plates (9, 10, 11, 12) of the inner chain links (3) are arranged on the sleeves (19) and the link plates (5, 6, 7, 8) of the outer chain links (2) are arranged on the pins (18), and wherein the outer-chain-link link plate (7, 8), which is arranged on the pin (18), and the inner-chain-link link plate (9, 10), which is arranged on the sleeve (19) and located adjacent to the outer-chain-link link plate (7, 8), are oriented such that their teeth project in the same direction, and the sprockets (13, 21) have arranged thereon at least two spaced-apart gear rims (14, 15, 16) which are in meshing engagement with the teeth of the tooth chain (1) facing the sprocket (13, 21).
